(19) United States
(12) Patent Application Publication
(10) Pub. No.: US 2016/0094549 A1
(43) Pub. Date: Mar. 31, 2016

(54) Electronic Tag and Authentication Method, Device and System thereof

(71) Applicant: GOLDEN VAST MACAO COMMERCIAL OFFSHORE LIMITED

(72) Inventor: KwokFong WONG, Heshan City (CN)

(21) Appl. No.: 14/858,375

(22) Filed: Sep. 18, 2015

(30) Foreign Application Priority Data
Sep. 26, 2014 (CN) 201410505924.7

(51) Int. Cl. H04L 29/06; G06K 19/07; G06K 19/06

(52) U.S. Cl. CPC H04L 63/0861; G06K 19/06037; G06K 19/0703

(57) ABSTRACT

The invention discloses an electronic tag and authentication method, device and system thereof. The authentication method of the electronic tag comprises: a first terminal generating a two-dimensional code of a product, sending the two-dimensional code to a second terminal and providing the two-dimensional code in an electronic tag of the product; the second terminal reading the two-dimensional code in the electronic tag, and authenticating the electronic tag according to the two-dimensional code sent from the first terminal; the second terminal sending an activation instruction to the electronic tag if authentication is successful; and the electronic tag changing colors according to the activation instruction. As compared with the prior art, the identify authentication of the users corresponding to the first terminal and the second terminal is achieved in the invention, and the results of authentication are more intuitive due to the color change of the electronic tag.

### FIELD OF THE INVENTION

The invention relates to the filed of authentication technology, and more particularly to an electronic tag and authentication method, device and system thereof.

### DESCRIPTION OF THE RELATED ART

In the existing authentication technology, when a product is manufactured by a manufacturer, generally a two-dimensional code of the product generated based on the authorization of authority is set in a tag of the product, and a customer read the two-dimensional code to authenticate using a relevant software after buying the product. However, with the development of online shopping, a merchant and a customer usually reach a purchase agreement on the Internet because the merchant and the customer can not do transaction face to face, and the goods is transported by a logistics company. Thus, the customer needs to confirm the received product is sent out by the specified merchant, and the merchant also needs to confirm the receiving party is the real buyer. Based on the existing tag authentication technology, obviously the above problem can not be solved.

### SUMMARY OF THE INVENTION

An object of the invention is to provide an electronic tag and authentication method, device and system of the electronic tag, so that identity authentication of users at two terminals is achieved.

Based on this, in a first aspect, an embodiment of the invention provides an electronic tag authentication method comprising:

S11, a first terminal generating a two-dimensional code of a product, sending the two-dimensional code to a second terminal and providing the two-dimensional code in an electronic tag of the product;

S12, the second terminal reading the two-dimensional code in the electronic tag, and authenticating the electronic tag according to the two-dimensional code sent from the first terminal;

S13, the second terminal sending an activation instruction to the electronic tag if authentication is successful; and

S14, the electronic tag changing colors according to the activation instruction. In a first possible implementation way according to the first aspect of the invention, the step of the first terminal generating the two-dimensional code of the product comprises:

the first terminal generating the two-dimensional code of the product according to identification information of a second user and the product information, the second user is corresponding to the second terminal

In combination with the first possible implementation way according to the first aspect of the invention, in a second possible implementation way according to the first aspect of the invention, before the step of S11, the method also comprises:

S10, the first terminal obtaining the biological information of the second user and generating a first key according to the biological information of the second user, the second terminal obtaining biological information of a first user and generating a second key according to the biological information of the first user, wherein the first user is corresponding to the first terminal and the first key is corresponding to the second key;

the step of the first terminal generating the two-dimensional code of the product according the identification information of the second user and the product information comprises the first terminal generating the two-dimensional code of the product according to the first key and the product information;

the step of S12 comprises the second terminal reading the two-dimensional code in the electronic tag, and authenticating the first key according to the second key after obtaining the product information and the first key according to the two-dimensional code.

In a second aspect, an embodiment of the invention provides an electronic tag authentication system comprising a first terminal, a second terminal and an electronic tag.

The first terminal is used for generating a two-dimensional code of a product, sending the two-dimensional code to the second terminal and providing the two-dimensional code in the electronic tag.

The second terminal is used for reading the two-dimensional code in the electronic tag, authenticating the electronic tag according to the two-dimensional code sent from the first terminal, and sending an activation instruction to the electronic tag if authentication is successful.

The electronic tag is used for changing colors according to the activation instruction. In a first possible implementation way according to the second aspect of the invention, the first terminal is used for generating the two-dimensional code of the product according to identification information of a second user and product information, the second user is corresponding to the second terminal.

In combination with the first possible implementation way according to the second aspect of the invention, in a second possible implementation way according to the second aspect of the invention, the first terminal is used for obtaining the biological information of the second user and generating a first key according to the biological information of the second user, and generating the two-dimensional code of the product according to the first key and the product information,

The second terminal is used for obtaining biological information of a first user, generating a second key according to the biological information of the first user and authenticating the first key according to the second key after obtaining the product information and the first key according to the two-dimensional code.

The first user is corresponding to the first terminal, and the first key is corresponding to the second key.

In a third aspect, the invention also provides an electronic tag authentication method comprising:

S21, obtaining a two-dimensional code sent from a first terminal and storing it;

S22, reading a two-dimensional code in an electronic tag of a product, and authenticating the two-dimensional code in the electronic tag according to the stored two-dimensional code; and

S23, sending an activation instruction to the electronic tag if authentication is successful, so that the electronic tag changes colors according to the activation instruction.

In a first possible implementation way according to the third aspect of the invention, before the step of S21 the method also comprises:

S20, obtaining biological information of a first user and generating a second key according to the biological information of the first user.

The step of S22 comprises reading the two-dimensional code of the electronic tag, and authenticating the first key according to the second key after obtaining product information and a first key according to the two-dimensional code, wherein the two-dimensional code is generated by the first terminal according to the product information and the first key, and the first key is generated by the first terminal according to biological information of a second user.

The first user is corresponding to the first terminal and the first key is corresponding to the second key.

In a fourth aspect of the invention, an embodiment of the invention also provides an electronic tag authentication device comprising:

a two-dimensional code obtaining unit for obtaining a two-dimensional code sent from a first terminal and storing it;

a reading unit for reading a two-dimensional code in an electronic tag of a product;

an authentication unit for authenticating the two-dimensional code in the electronic tag according to the stored two-dimensional code;

an activation instruction sending unit for sending an activation instruction to the electronic tag when authentication is successful, so that the electronic tag changes colors according to the activation instruction.

In a first possible implementation way according to the fourth aspect of the invention, the tag authentication device also comprises:

a biological information obtaining unit for obtaining biological information of a first user, and generating a second key according to the biological information of the first user.

The authentication unit is used for authenticating a first key according to the second key after obtaining product information and a first key according to the two-dimensional code;

The two-dimensional code is generated by the first terminal according to the product information and the first key. The first key is generated by the first terminal according to biological information of a second user. The first user is corresponding to the first terminal and the first key is corresponding to the second key.

In a fifth aspect of the invention, an embodiment of the invention also provides an electronic tag comprising a control chip, a converting unit, a display unit and a battery.

The control chip is used for receiving an activation instruction sent from a first terminal and sending a conversion command to the converting unit according to the activation instruction.

The converting unit is used for changing colors according to the conversion command.

The display unit is used for displaying the color of the electronic tag.

The battery is used for supplying power for the control chip, the converting unit and the display unit.

In a first possible implementation way according to the fifth aspect of the invention, the control chip is used for determining whether the activation instruction is received for the first time or not, and sending the conversion command to the converting unit if yes, and not sending the conversion command to the converting unit if not.

The invention has the following advantages:

in the invention the first terminal sends the generated two-dimensional code of a product to a second terminal and sets the two-dimensional code in the electronic tag of the product, so that the second terminal can read the two-dimensional code in the electronic tag of the product and authenticates it according to the previously stored two-dimensional code. Based on this, if a user is not from the second terminal or a product doesn't belong to the user at the first terminal, then the two-dimensional code at the second terminal will be incorrect or the two-dimensional code in the electronic tag of the product will be incorrect, and thus the authentication can not be achieved and the electronic tag will not change colors. From this, as compared with the prior art, the identity authentication of users at two terminals is achieved.

### BRIEF DESCRIPTION OF THE DRAWINGS

In order to illustrate more clearly the technical solutions of the embodiments of the invention, the drawings used in the embodiments will be described simply hereinafter. Obviously, the drawings are given only by way of example, and for a person skilled in the art, other equivalent drawings can be obtained according to these drawings without any creative work.

FIG. 1 is a flow chart of a method according to an embodiment 1 of the invention.

FIG. 2 is a schematic drawing of an electronic tag according to an embodiment 2 of the invention.

FIG. 3 is a schematic drawing of a system according to an embodiment 3 of the invention.

FIG. 4 is a schematic drawing of a device according to an embodiment 5 of the invention.

### DETAILED DESCRIPTION OF THE INVENTION

In order to make the object, technical solutions and advantages of the invention more clearly, the technical solutions of the embodiments of the invention will be described hereinafter fully and clearly in connection with drawings. It is obvious, that the embodiments to be described just are parts of the embodiments of the invention, instead of all of the embodiments. Based on the embodiments of the invention, the other embodiments obtained by one skilled in the art without any creative work are covered by the protection scope of the invention.

The core of the invention is in that: a two-dimensional code of a product generated by a first terminal is not only sent to a second terminal, but also is set in an electronic tag of the product. After receiving the product, a second user obtains the two-dimensional code in the electronic tag of the product by means of the second terminal and authenticates it according to the previously stored two-dimensional code. If authentication is successful, then the second terminal sends an instruction to activate the electronic tag such that it changes colors.

The above process can be applied in various situations. Taking a merchant and a customer as example, after a purchase agreement is reached, a two-dimensional code of goods is generated by the merchant by means of a first terminal, and the two-dimensional code is not only sent to the customer at the second terminal, but also is set in an electronic tag of the goods, then the goods will be transported to the customer by a logistics company. After receiving the goods, the customer obtains the two-dimensional code in the electronic tag by means of the second terminal and authenticates according to the two-dimensional code sent from the first terminal. If authentication is successful, the second terminal sends an instruction to activate the electronic tag such that it change colors. Based on this, if the customer is an illegal user, i.e., an unreal buyer, then the two-dimensional code at the second terminal is false, and will not match with the two-dimensional in the electronic tag. Similarly, if a merchant is not the specified merchant, then the two-dimensional code in the electronic tag is false, and will not match with the two-dimensional code at the second terminal, and thus the electronic tag will not be activated to change colors. From this, in the above process identify authentication is achieved for the merchant and the customer. In the case of current prevailing online shopping, the security of transaction is greatly improved. Furthermore, the results of authentication can be intuitively displayed by means of the color change of electronic tag.

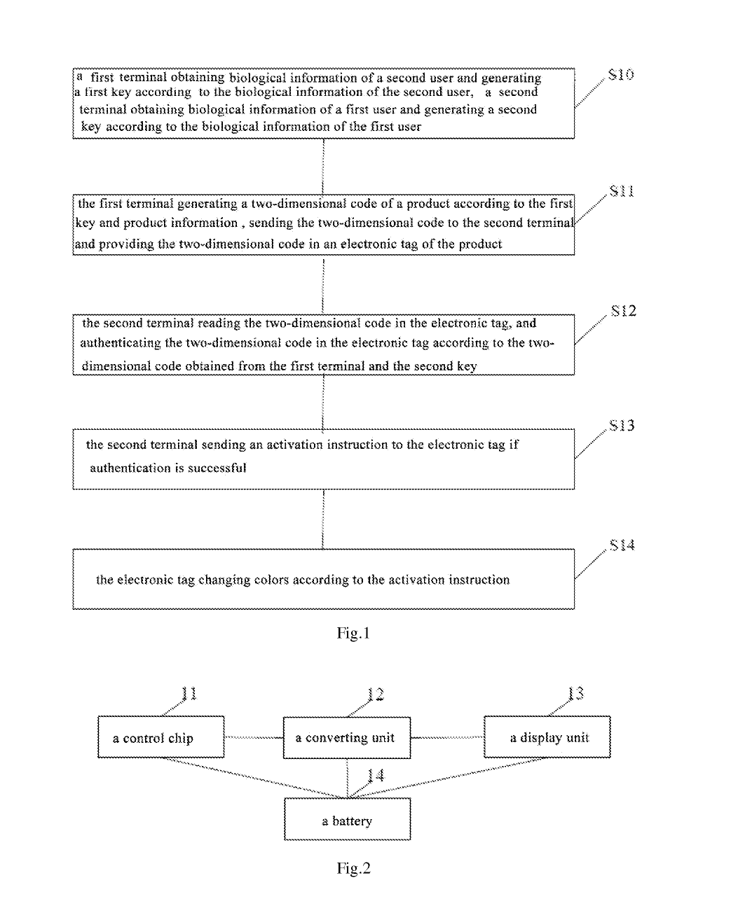

As shown in FIG. 1, an embodiment 1 of the invention provides an electronic tag authentication method comprising:

S11, a first terminal generating a two-dimensional code of a product, and sending the two-dimensional code to a second terminal and providing the two-dimensional code in an electronic tag of the product. Specifically, the first terminal generates the two-dimensional code of the product according to identification information of a second user and product information, the second user is corresponding to the second terminal, such as the above customer.

When this method is applied between a merchant and a customer, the first terminal also may further generate a two-dimensional code in combination with purchasing information and merchant information.

S12, the second terminal reading the two-dimensional code in the electronic tag, and authenticating the electronic tag according to the two-dimensional code sent from the first terminal.

S13, the second terminal sending an activation instruction to the electronic tag if authentication is successful.

S14, the electronic tag changing colors according to the activation instruction.

In order to further improve the security, before the step of S11, the method also comprises:

S10, the first terminal obtaining the biological information of the second user and generating a first key according to the biological information of the second user, the second terminal obtaining biological information of a first user and generating a second key according to the biological information of the first user, wherein the first user is corresponding to the first terminal and the first key is corresponding to the second key.

Now the step of S11 specifically is: the first terminal generates the two-dimensional code of the product according to the first key and the product information, and sends the two-dimensional code to the second terminal and provides the two-dimensional code in the electronic tag of the product.

At this moment the step S12 specifically is: the second terminal reads the two-dimensional code in the electronic tag, and authenticates the two-dimensional code in the electronic tag according to the two-dimensional code obtained from the first terminal and the second key. Specifically, firstly the two-dimensional code in the electronic tag is authenticated by means of the two-dimensional code obtained from the first terminal, and after the product information and first key is obtained, the first key is authenticated according to the second key.

For example, the merchant and the customer can exchange their biological information such as respective fingerprint using a same platform. Then, the first terminal of the merchant achieves the generation and matching of keys according to the obtained biological information. The merchant generates a two-dimensional code in combination with merchant information, purchasing information and the key generated according to the biological information of the customer, and sends the two-dimensional code to the second terminal and sets it in an electronic tag. After reading the two-dimensional code of the electronic tag, the second terminal will achieve authentication according to the previously obtained two-dimensional code to obtain the corresponding merchandise information, purchasing information and a key. Then the second terminal matches the stored key corresponding to the merchant biological information with the key in the electronic tag. If they match with each other, then the authentication is successful, and then the second terminal will send an activation instruction to the electronic tag such that it changes colors hereby.

Referring to FIG. 2, the FIG. 2 shows the schematic drawing of an electronic tag of embodiment 2 of the invention. The electronic tag comprises a control chip 11, a converting unit 12, a display unit 13 and a battery 14.

The control chip 11 is used for receiving an activation instruction sent from a first terminal and sending a conversion command to the converting unit 12 according to the activation instruction.

The converting unit 12 is used for changing colors according to the conversion command.

The display unit 13 is used for displaying the color of the electronic tag.

The battery 14 is used for supplying power for the control chip 11, the converting unit 12 and the display unit 13.

In a first possible implementation way according to the fifth aspect of the invention, the control chip is used for determining whether the activation instruction is received for the first time or not, and sending the conversion command to the converting unit if yes, and not sending the conversion command to the converting unit if not.

The above battery 14 can maintain the power for activating color change.

It is noted that, the electronic tag of the invention can be designed so that it is invalid and can not change colors after one-time activation. Specifically, the battery can be set such that it's power only can maintain one-time color change, or alternatively the receiving times of the activation instruction are determined by the control chip, if receiving for the first time, the conversion command is sent to the converting unit, otherwise the conversion command will not be sent to the converting unit.

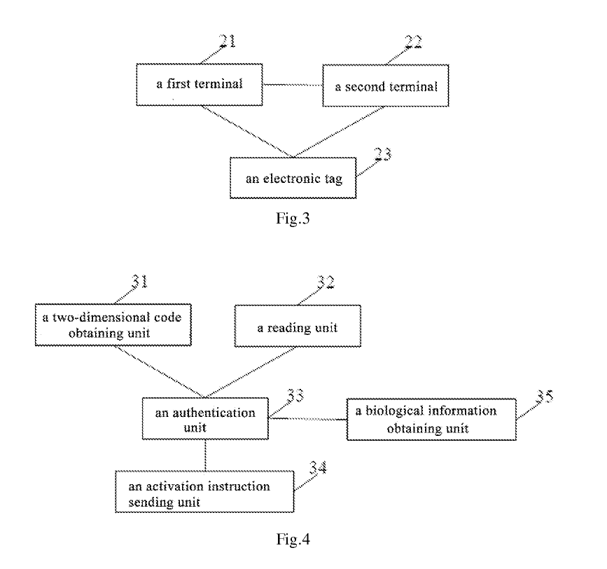

Corresponding to the above method, an embodiment 3 of the invention also provides an electronic tag authentication system, as shown in FIG. 3, this system comprises a first terminal 21, a second terminal 22 and an electronic tag 23.

The first terminal 21 is used for generating a two-dimensional code of a product, sending the two-dimensional code to the second terminal 22 and providing the two-dimensional code in the electronic tag 23.

The second terminal 22 is used for reading the two-dimensional code in the electronic tag 23, and authenticating the electronic tag 23 according to the two-dimensional code sent from the first terminal 21, and sending an activation instruction to the electronic tag 23 if authentication is successful;

The electronic tag 23 is used for changing colors according to the activation instruction.

In order to further improve the security of transaction, the first terminal 21 may generate the two-dimensional code of the product according to identification information of a second user and product information, wherein second user is corresponding to the second terminal.

The above identification information may be generated by the biological information of the second user.

Now the first terminal 21 is used for obtaining the biological information of the second user and generating a first key according to the biological information of the second user, and generating the two-dimensional code of the product according to the first key and the product information.

The second terminal 22 is used for obtaining biological information of a first user, and generating a second key according to the biological information of the first user and authenticating the first key according the second key after obtaining the product information and the first key according to the two-dimensional code.

The first user is corresponding to the first terminal 21, and the first key is corresponding to the second key.

It should be noted that, for obtaining the biological information, a biological information obtaining device can be configured independently, or it can be integrated into the first terminal and the second terminal, and this is not limited in the invention. In this system, the specific structure of the electronic tag 23 can be seen in FIG. 2. Corresponding to the above embodiment, the embodiment 4 of the invention also provides an electronic tag authentication method. Applying in the above second terminal, the method comprises:

S21, obtaining a two-dimensional code sent from a first terminal and storing it;

S22, reading a two-dimensional code in an electronic tag of a product, and authenticating the two-dimensional code in the electronic tag according to the stored two-dimensional code; and

S23, sending an activation instruction to the electronic tag if authentication is successful, so that the electronic tag changes colors according to the activation instruction.

In order to further improve the security, before the step of S21 the method also comprises:

S20, obtaining biological information of a first user and generating a second key according to the biological information of the first user.

Now the step of S22 comprises reading the two-dimensional code of the electronic tag, and authenticating the first key according to the second key after obtaining product information and a first key according to the two-dimensional code. The two-dimensional code is generated by the first terminal according to the product information and the first key. The first key is generated by the first terminal according to biological information of a second user. The first user is corresponding to the first terminal and the first key is corresponding to the second key.

Corresponding to the method of embodiment 4, the embodiment 5 of the invention also provides an electronic tag authentication deice, as shown in FIG. 4, the authentication device comprises:

a two-dimensional code obtaining unit 31 for obtaining a two-dimensional code sent from a first terminal and storing it;

a reading unit 32 for reading a two-dimensional code in an electronic tag of a product;

an authentication unit 33 for authenticating the two-dimensional code in the electronic tag according to the stored two-dimensional code;

an activation instruction sending unit 34 for sending an activation instruction to the electronic tag when the authentication is successful, so that the electronic tag changes colors according to the activation instruction.

Optionally, the authentication device also comprises:

a biological information obtaining unit 35 for obtaining biological information of a first user, and generating a second key according to the biological information of the first user.

Specifically the authentication unit 33 is used for authenticating a first key according to the second key after obtaining product information and the first key according to the two-dimensional code;

The two-dimensional code is generated by the first terminal according to the product information and the first key. The first key is generated by the first terminal according to biological information of a second user. The first user is corresponding to the first terminal and the first key is corresponding to the second key.

The above first terminal may specifically be a computer, a notebook or a mobile terminal. The above second terminal may specifically be a computer, a notebook, preferably a mobile terminal such as a mobile phone and a tablet computer. Corresponding application software's are mounted in both the above first terminal and second terminal.

In an embodiment 6 of the invention, both the first terminal and the second terminal comprise an executor and a storage, wherein executing codes are stored in the storage. The executor is used for performing the corresponding operations according to the stored executing codes therein.

The above electronic tag authentication technology also provides an effective anti-fake method of an electronic tag.

The above embodiments only are preferred embodiments of the invention. It should be noted that, for one skilled in the art, some improvements and modifications may be made without departing from the principle of the invention, and these improvements and modifications shall be covered in the extent of protection of the invention.

What is claimed is:

1. An electronic tag authentication method, comprises the steps of:
S11, a first terminal generating a two-dimensional code of a product, sending the two-dimensional code to a second terminal and providing the two-dimensional code in an electronic tag of the product;
S12, the second terminal reading the two-dimensional code in the electronic tag, and authenticating the electronic tag according to the two-dimensional code sent from the first terminal;
S13, the second terminal sending an activation instruction to the electronic tag if authentication is successful; and
S14, the electronic tag changing colors according to the activation instruction.

2. The electronic tag authentication method as claimed in claim 1, wherein the step of the first terminal generating the two-dimensional code of the product comprises:
the first terminal generating the two-dimensional code of the product according to identification information of a second user and product information, the second user being corresponding to the second terminal.

3. The electronic tag authentication method as claimed in claim 2, wherein before the step of S11, the method also comprises:
S10, the first terminal obtaining biological information of the second user and generating a first key according to the biological information of the second user, the second terminal obtaining biological information of a first user and generating a second key according to the biological information of the first user, wherein the first user is corresponding to the first terminal and the first key is corresponding to the second key;
the step of the first terminal generating the two-dimensional code of the product according the identification information of the second user and the product information comprising the first terminal generating the two-dimensional code of the product according to the first key and the product information;
the step of S12 comprising the second terminal reading the two-dimensional code in the electronic tag, and authenticating the first key according to the second key after obtaining the product information and the first key according to the two-dimensional code.

4. An electronic tag authentication system comprising a first terminal, a second terminal and an electronic tag,
wherein the first terminal is used for generating a two-dimensional code of a product, sending the two-dimensional code to the second terminal and providing the two-dimensional code in the electronic tag;
the second terminal being used for reading the two-dimensional code in the electronic tag, authenticating the electronic tag according to the two-dimensional code sent from the first terminal, and sending an activation instruction to the electronic tag if authentication is successful;
the electronic tag being used for changing colors according to the activation instruction.

5. The electronic tag authentication system as claimed in claim 4, wherein the first terminal is used for generating the two-dimensional code of the product according to identification information of a second user and product information, the second user being corresponding to the second terminal.

6. The electronic tag authentication system as claimed in claim 5, wherein
the first terminal is used for obtaining the biological information of the second user and generating a first key according to the biological information of the second user, and generating the two-dimensional code of the product according to the first key and the product information,
the second terminal being used for obtaining biological information of a first user, generating a second key according to the biological information of the first user, and authenticating the first key according to the second key after obtaining the product information and the first key according to the two-dimensional code;
the first user being corresponding to the first terminal, and the first key being corresponding to the second key.

7. An electronic tag authentication method comprises:
S21, obtaining a two-dimensional code sent from a first terminal and storing it;
S22, reading a two-dimensional code in an electronic tag of a product, and authenticating the two-dimensional code in the electronic tag according to the stored two-dimensional code; and
S23, sending an activation instruction to the electronic tag if authentication is successful, so that the electronic tag changes colors according to the activation instruction.

8. The electronic tag authentication method as claimed in claim 7, wherein before the step of S21 the method also comprises:
S20, obtaining biological information of a first user and generating a second key according to the biological information of the first user;
the step of S22 comprising reading the two-dimensional code of the electronic tag, and authenticating the first key according to the second key after obtaining product information and a first key according to the two-dimensional code, wherein the two-dimensional code is generated by the first terminal according to the product information and the first key, and the first key is generated by the first terminal according to biological information of a second user;
the first user being corresponding to the first terminal and the first key being corresponding to the second key.

9. An electronic tag authentication device comprises:
a two-dimensional code obtaining unit for obtaining a two-dimensional code sent from a first terminal and storing it;
a reading unit for reading a two-dimensional code in an electronic tag of a product;
an authentication unit for authenticating the two-dimensional code in the electronic tag according to the stored two-dimensional code;
an activation instruction sending unit for sending an activation instruction to the electronic tag when authentication is successful, so that the electronic tag changes colors according to the activation instruction.

10. The electronic tag authentication device as claimed in claim 9, wherein the device also comprises:
a biological information obtaining unit for obtaining biological information of a first user, and generating a second key according to the biological information of the first user;
the authentication unit being used for authenticating a first key according to the second key after obtaining product information and a first key according to the two-dimensional code;
the two-dimensional code being generated by the first terminal according to the product information and the first key, the first key being generated by the first terminal according to biological information of a second user, the first user being corresponding to the first terminal and the first key being corresponding to the second key.

11. An electronic tag comprising a control chip, a converting unit, a display unit and a battery, wherein
the control chip is used for receiving an activation instruction sent from a first terminal and sending a conversion command to the converting unit according to the activation instruction;
the converting unit being used for changing colors according to the conversion command;
the display unit being used for displaying the color of the electronic tag; and
the battery being used for supplying power for the control chip, the converting unit and the display unit.

12. The electronic tag as claimed in claim 11, wherein the control chip is used for determining whether the activation instruction is received for the first time or not, and sending the conversion command to the converting unit if yes, and not sending the conversion command to the converting unit if not.
